(19) United States
(12) Patent Application Publication
(10) Pub. No.: US 2024/0304182 A1
(43) Pub. Date: Sep. 12, 2024

(54) SYSTEM AND METHOD FOR ACTIVATING AN ARTIFICIAL INTELLIGENCE-BASED RECOMMENDATION

(71) Applicant: The Toronto-Dominion Bank, Toronto (CA)

(72) Inventors: Gregory James HAMILTON, Toronto (CA); Na-Hyun Sophie PARK, Toronto (CA); Maryam KARBASI, Toronto (CA); Michael R.C. KEALEY, Toronto (CA); Matthew James LEE, Toronto (CA)

(73) Assignee: The Toronto-Dominion Bank, Toronto (CA)

(21) Appl. No.: 18/180,432

(22) Filed: Mar. 8, 2023

(51) Int. Cl. G10L 15/16; G06N 5/02; G10L 15/22

(52) U.S. Cl. CPC G10L 15/16; G06N 5/027; G10L 15/22; G10L 2015/221; G10L 2015/225

(57) ABSTRACT

A server computer system comprises a communications module; a processor coupled with the communications module; and a memory coupled to the processor and storing processor-executable instructions which, when executed by the processor, configure the processor to engage an artificial intelligence (AI) engine to analyze voice data to identify a string of commands; and generate at least one recommendation based on the string of commands; send, via the communications module to a first device, a signal causing the first device to output a message that includes the at least one recommendation; receive, via the communications module and from the first device, a signal that includes voice data for activating the at least one recommendation; and activate the at least one recommendation.

### TECHNICAL FIELD

The present application relates to methods and systems for activating an artificial intelligence-based recommendation.

### BACKGROUND

Voice assistants such as those available via smart speaker devices may be used to perform a variety of functions. Oftentimes, these voice assistants require a large amount of computing resources to perform the variety of functions.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a high-level schematic diagram showing components of an example electronic device;

FIG. 3 is a simplified schematic diagram showing components of a computing device;

FIG. 4 is a high-level schematic diagram of an example computer device;

FIG. 5 shows a simplified organization of software components stored in a memory of the example computer device of FIG. 4;

FIG. 6 is a flowchart showing operations performed by an artificial intelligence engine of a server computer system in generating at least one recommendation according to an embodiment;

FIG. 7 is a flowchart showing operations performed by a server computer system in activating an artificial intelligence-based recommendation according to an embodiment;

FIG. 8 is a flowchart showing operations performed by a server computer system in causing a first device to output a message that includes data based on the at least one recommendation according to an embodiment;

FIG. 9 is a flowchart showing operations performed by a server computer system in defining an intent or command for activating a shortcut according to an embodiment; and

FIG. 10 is a flowchart showing operations performed by a server computer system in sending, to a second device, a signal that includes sensitive data according to an embodiment.

Like reference numerals are used in the drawings to denote like elements and features.

### DETAILED DESCRIPTION OF VARIOUS EMBODIMENTS

Accordingly, in one aspect there is provided a server computer system comprising a communications module; a processor coupled with the communications module; and a memory coupled to the processor and storing processor-executable instructions which, when executed by the processor, configure the processor to engage an artificial intelligence (AI) engine to analyze voice data to identify a string of commands; and generate at least one recommendation based on the string of commands; send, via the communications module to a first device, a signal causing the first device to output a message that includes the at least one recommendation; receive, via the communications module and from the first device, a signal that includes voice data for activating the at least one recommendation; and activate the at least one recommendation.

In one or more embodiments, the processor-executable instructions, when executed by the processor, further configure the processor to analyze, in real-time, voice data received from the first device to determine a trigger for the at least one recommendation; and send, via the communications module and to the first device, a signal causing the first device to output a message that includes data based on the at least one recommendation.

In one or more embodiments, the processor-executable instructions, when executed by the processor, further configure the processor to obtain the data based on the at least one recommendation from at least one data record.

In one or more embodiments, the voice data includes historical voice data based on one or more completed sessions with the first device.

In one or more embodiments, the string of commands includes a sequence of two or more commands and the recommendation includes automatically causing the first device to output data based on a second command of the sequence of the two or more commands in response to causing the first device to output data based on a first command of the sequence of the two or more commands.

In one or more embodiments, the recommendation includes activating a shortcut for causing the server computer system to perform one or more operations.

In one or more embodiments, the processor-executable instructions, when executed by the processor, further configure the processor to send, via the communications module and to the first device, a signal causing the first device to output a message requesting that an intent or command be defined to activate the shortcut; and receive, via the communications module and from the first device, a signal that includes voice data defining the intent or the command for activating the shortcut.

In one or more embodiments, the processor-executable instructions, when executed by the processor, further configure the processor to determine that data to be output by the first device includes sensitive data; send, to the first device, a signal causing the first device to output a message that includes a request for confirmation that the output of the sensitive data is to be sent to the first device or sent to a second device that is different than the first device; receive, via the communications module and from the first device, a signal that includes voice data requesting that the sensitive data be sent to the second device that is different than the first device; and send, via the communications module and to the second device, a signal that includes the sensitive data.

In one or more embodiments, the sensitive data is sent to the second device via text message.

In one or more embodiments, the processor-executable instructions, when executed by the processor, further configure the processor to receive, via the communications module and from the first device, a signal that includes authentication information; identify, based on the authentication information, one or more accounts; and obtain, from a database, the voice data based on the one or more accounts.

According to another aspect there is provided a computer-implemented method performed by a processor of a computer server system, the method comprising engage an artificial intelligence (AI) engine to analyze voice data to identify a string of commands; and generate at least one recommendation based on the string of commands; send, via a communications module to a first device, a signal causing the first device to output a message that includes the at least one recommendation; receive, via the communications module and from the first device, a signal that includes voice data for activating the at least one recommendation; and activate the at least one recommendation.

In one or more embodiments, the method further comprises analyzing, in real-time, voice data received from the first device to determine a trigger for the at least one recommendation; and sending, via the communications module and to the first device, a signal causing the first device to output a message that includes data based on the at least one recommendation.

In one or more embodiments, the method further comprises obtaining the data based on the at least one recommendation from at least one data record.

In one or more embodiments, the voice data includes historical voice data based on one or more completed sessions with the first device.

In one or more embodiments, the string of commands includes a sequence of two or more commands and the recommendation includes automatically causing the first device to output data based on a second command of the sequence of the two or more commands in response to causing the first device to output data based on a first command of the sequence of the two or more commands.

In one or more embodiments, the recommendation includes activating a shortcut for causing the server computer system to perform one or more operations.

In one or more embodiments, the method further comprises sending, via the communications module and to the first device, a signal causing the first device to output a message requesting that an intent or command be defined to activate the shortcut; and receiving, via the communications module and from the first device, a signal that includes voice data defining the intent or the command for activating the shortcut.

In one or more embodiments, the method further comprises determining that data to be output by the first device includes sensitive data; sending, to the first device, a signal causing the first device to output a message that includes a request for confirmation that the output of the sensitive data is to be sent to the first device or sent to a second device that is different than the first device; receiving, via the communications module and from the first device, a signal that includes voice data requesting that the sensitive data be sent to the second device that is different than the first device; and sending, via the communications module and to the second device, a signal that includes the sensitive data.

In one or more embodiments, the sensitive data is sent to the second device via text message.

According to another aspect there is provided a non-transitory computer readable storage medium comprising computer-executable instructions which, when executed, configure a processor of a computer server system to engage an artificial intelligence (AI) engine to analyze voice data to identify a string of commands; and generate at least one recommendation based on the string of commands; send, via a communications module to a first device, a signal causing the first device to output a message that includes the at least one recommendation; receive, via the communications module and from the first device, a signal that includes voice data for activating the at least one recommendation; and activate the at least one recommendation.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

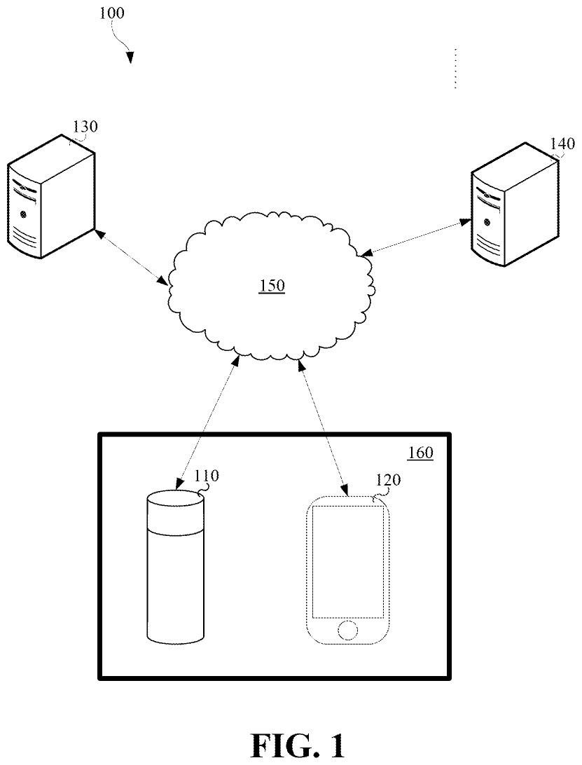

FIG. 1 is a block diagram illustrating an operating environment of an example embodiment. Various components cooperate to provide a system 100 which may be used, for example, to activate an artificial intelligence-based recommendation. As shown, the system 100 includes a first device 110, a second device 120, a first server computer system 130 and a second server computer system 140 coupled to one another through a network 150.

In this embodiment, the first device 110 and the second device 120 are disposed in an environment 160. Put another way, the first device 110 and the second device 120 are physically proximate.

The first device 110 is configured to communicate with the first server computer system 130 via the network 150 and vice-versa. The first server computer system 130 may be remote from the environment 160.

The first device 110 is configured to communicate with the second server computer system 140 via the network 150 and vice-versa. The second server computer system 140 may be remote from the environment 160.

The second device 120 is configured to communicate with the second server computer system 140 via the network 150 and vice-versa. The second server computer system 140 may be remote from the environment 160.

The first server computer system 130 is configured to communicate with the second server computer system 140 via the network 150 and vice-versa. The first server computer system 130 may be remote from the second server computer system 140.

The first device 110 is a computer system. In this embodiment, the first device 110 is a smart speaker. For example, the first device 110 may be a Google Home speaker or an Amazon Echo. The first device 110 may include one or more microphones for capturing acoustic signals (sounds) from the environment proximate the first device 110 (i.e. the environment 160) and one or more speakers for providing acoustic signals to the environment proximate the first device 110. Additionally or alternatively, the first device 110 may include one or more other components such as, for example, a hardware processor. The first device 110 may be adapted to provide a voice assistant. A user may interact with the first device 110 by providing voice utterances and the first device 110 may provide acoustic signals responsive to the voice utterances. In this way, the first device 110 may be used to activate an artificial intelligence-based recommendation.

The second device 120 may be, for example, a smartphone as shown. The second device 120 may, however, be a computing device of another type such as for example a personal computer, a laptop computer, a tablet computer, a notebook computer, a hand-held computer, a personal digital assistant, a portable navigation device, a mobile phone, a smart phone, a wearable computing device (e.g. a smart watch, a wearable activity monitor, wearable smart jewelry, a glasses and other optical devices that include optical head-mounted displays), and any other type of computing device that may be configured to store data and software instructions, and execute software instructions to perform operations consistent with disclosed embodiments.

The first server computing system 130 may have a trust relationship with the first device 110. Specifically, the first device 110 may trust the first server computer system 130 and/or the first server computer system 130 may trust the first device 110. For example, it may be that an account links the first device 110 and first server computer system 130 and that the first server computer system 130 trusts the first device 110 because it has authenticated with the first server computer system 130 relative to the account. The account may be, for example, a Google account where the first device 110 is a Google Home speaker. In another example, the account may be an Amazon account where the first device 110 is an Amazon Echo. The first server computer system 130 may service the first device 110 such as, for example, by providing a natural language processing service utilized by a voice assistant provided by the first device 110. In providing such a service and/or other services, the first server computer system 130 may perform one or more functions responsive to input received from the first device 110. Such functions may, as further described below, include determining one or more intents or commands associated with input (e.g. utterances) received from the first device 110 via the network 150. Additionally or alternatively, such functions may, as further described below, include communicating with the second server computer system 140.

The first server computer system 130 may include a plug-in module configured to enable one or more plug-ins capable of processing various tasks and/or operations responsive to input received from the first device 110. The plug-in module may correspond to first party applications and/or third-party applications operable to perform different tasks or actions. For example, based on the context of audio received from the first device 110, the first server computer system 130 may use a certain application to retrieve or generate a response, which in turn may be communicated back to the first device 110.

The second server computer system 140 may be associated with a financial institution. In one or more embodiments, the second server computer system 140 may maintain customer bank accounts. That is, the second server computer system 140 may maintain a database that includes various data records. A data record may, for example, reflect an amount of value stored in a particular account associated with a user.

Each account maintained by the second server computer system 140 may be associated with authentication information. The authentication information may be or may include any one or more of a token, a username, a password, a personal identification number (PIN), biometric data, etc. The authentication information may be used by the second server computer system 140 to authenticate a device such as for example the first device 110 and/or the second device 120. More specifically, the authentication information may be used to determine that the first device 110 and/or second device 120 is/are being operated by an authorized user and to identify one or more accounts.

The first server computer system 130 and the second server computer system 140 are computer systems. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The network 150 is a computer network. The network 150 may include a public network such as the Internet and/or a private network. In some embodiments, the network 150 may be an internetwork such as may be formed of one or more interconnected computer networks. For example, the network 150 may be or may include an Ethernet network, a wireless network, a telecommunications network, or the like.

FIG. 1 illustrates an example representation of components of the system 100.

The system 100 can, however, be implemented differently than the example of FIG. 1. For example, various components that are illustrated as separate systems in FIG. 1 may be implemented on a common system. By way of further example, the functions of a single component may be divided into multiple components.

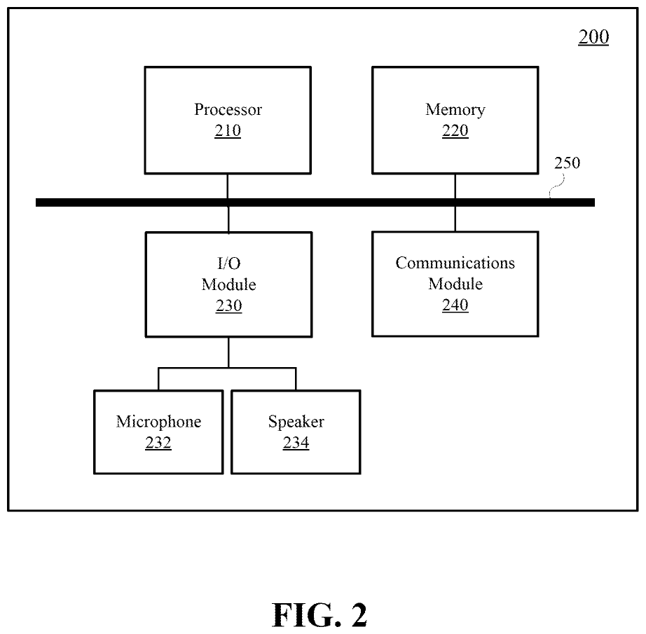

FIG. 2 is a simplified schematic diagram showing components of an electronic device 200. The first device 110 may be of the same type as the electronic device 200. The electronic device 200 includes a variety of modules. For example, as illustrated, the electronic device 200 may include a processor 210, a memory 220, an input/output module 230 and/or a communications module 240 in communication over a bus 250.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the electronic device 200.

The I/O module 230 is an input module and an output module. As an input module, the I/O module 230 allows the electronic device 200 to receive input from components of the electronic device 200. As an output module, the I/O module 230 allows the electronic device 200 to provide output to components of the electronic device 200. For example, the I/O module 230 may, as illustrated, be in communication with a microphone 232 and a speaker 234. The microphone 232 may include one or more microphones which may, for example, form a microphone array. The microphone 232 may be employed for capturing acoustic signals from the environment proximate the electronic device 200. The speaker 234 may include one or more speakers for providing acoustic signals to the environment proximate the electronic device 200. In summary, the I/O module 230 may allow the electronic device 200 to receive input via a microphone 232 and provide output via a speaker 234.

The communications module 240 allows the electronic device 200 to communicate with other computing devices and/or various communications networks such as, for example, the network 150. The communications module 240 may allow the electronic device 200 to send or receive communications signals. Communications signals may be sent or received according to one or more protocols or according to one or more standards. For example, the communications module 240 may allow the electronic device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 240 may allow the electronic device 200 to communicate via Wi-Fi™, using Bluetooth™ or via some combination of one or more networks or protocols. In some embodiments, all or a portion of the communications module 240 may be integrated into a component of the electronic device 200. For example, the communications module 240 may be integrated into a communications chipset.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220. Such software may, for example, adapt the electronic device 200 to serve as a smart speaker such as, for example, to provide voice assistant services.

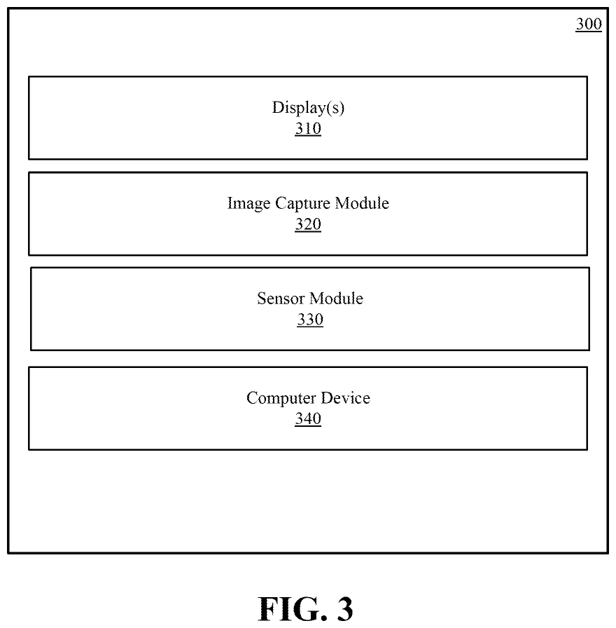

FIG. 3 is a simplified schematic diagram showing components of an exemplary computing device 300. In some embodiments, the second device 120 may be a computing device of the same type as computing device 300. The computing device 300 may include modules including, as illustrated, for example, one or more displays 310, an image capture module 320, a sensor module 330, and a computer device 340.

The one or more displays 310 are a display module. The one or more displays 310 are used to display screens of a graphical user interface that may be used, for example, to communicate with the second server computer system 140 (FIG. 1). The one or more displays 310 may be internal displays of the computing device 300 (e.g., disposed within a body of the computing device).

The image capture module 320 may be or may include a camera. The image capture module 320 may be used to obtain image data, such as images. The image capture module 320 may be or may include a digital image sensor system as, for example, a charge coupled device (CCD) or a complementary metal-oxide-semiconductor (CMOS) image sensor.

The sensor module 330 may be a sensor that generates sensor data based on a sensed condition. By way of example, the sensor module 330 may be or include a location subsystem which generates location data indicating a location of the computing device 300. The location may be the current geographic location of the computing device 300. The location subsystem may be or include any one or more of a global positioning system (GPS), an inertial navigation system (INS), a wireless (e.g., cellular) triangulation system, a beacon-based location system (such as a Bluetooth low energy beacon system), or a location subsystem of another type.

The computer device 340 is in communication with the one or more displays 310, the image capture module 320, and the sensor module 330. The computer device 340 may be or may include a processor which is coupled to the one or more displays 310, the image capture module 320, and/or the sensor module 330.

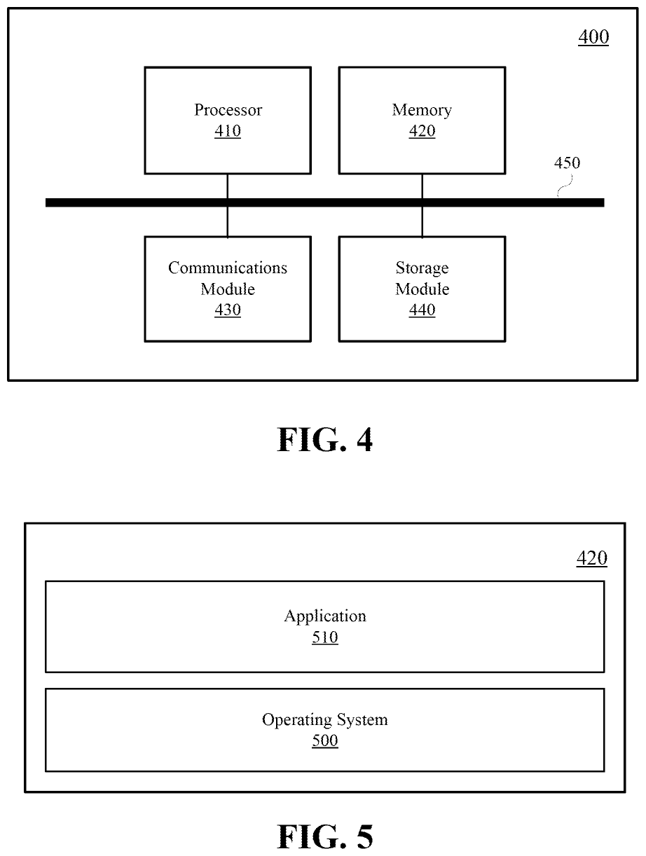

Referring now to FIG. 4, a high-level operation diagram of an example computer device 400 is shown. In some embodiments, the computer device 400 may be exemplary of the computer device 340 (FIG. 3), the first server computer system 130 and/or the second server computer system 140.

The example computer device 400 includes a variety of modules. For example, as illustrated, the example computer device 400 may include a processor 410, a memory 420, a communications module 430, and/or a storage module 440. As illustrated, the foregoing example modules of the example computer device 400 are in communication over a bus 450.

The processor 410 is a hardware processor. The processor 410 may, for example, be one or more ARM, Intel x86, PowerPC processors or the like.

The memory 420 allows data to be stored and retrieved. The memory 420 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computer device 400.

The communications module 430 allows the example computer device 400 to communicate with other computer or computing devices and/or various communications networks. For example, the communications module 430 may allow the example computer device 400 to send or receive communications signals. Communications signals may be sent or received according to one or more protocols or according to one or more standards. For example, the communications module 430 may allow the example computer device 400 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 430 may allow the example computer device 400 to communicate using near-field communication (NFC), via Wi-Fi™, using Bluetooth™ or via some combination of one or more networks or protocols. In some embodiments, all or a portion of the communications module 430 may be integrated into a component of the example computer device 400. For example, the communications module may be integrated into a communications chipset.

The storage module 440 allows the example computer device 400 to store and retrieve data. In some embodiments, the storage module 440 may be formed as a part of the memory 420 and/or may be used to access all or a portion of the memory 420. Additionally or alternatively, the storage module 440 may be used to store and retrieve data from persisted storage other than the persisted storage (if any) accessible via the memory 420. In some embodiments, the storage module 440 may be used to store and retrieve data in a database. A database may be stored in persisted storage. Additionally or alternatively, the storage module 440 may access data stored remotely such as, for example, as may be accessed using a local area network (LAN), wide area network (WAN), personal area network (PAN), and/or a storage area network (SAN). In some embodiments, the storage module 440 may access data stored remotely using the communications module 430. In some embodiments, the storage module 440 may be omitted and its function may be performed by the memory 420 and/or by the processor 410 in concert with the communications module 430 such as, for example, if data is stored remotely. The storage module may also be referred to as a data store.

Software comprising instructions is executed by the processor 410 from a computer-readable medium. For example, software may be loaded into random-access memory from persistent storage of the memory 420. Additionally or alternatively, instructions may be executed by the processor 410 directly from read-only memory of the memory 420.

FIG. 5 depicts a simplified organization of software components stored in the memory 420 of the example computer device 400 (FIG. 4). As illustrated, these software components include an operating system 500 and an application 510.

The operating system 500 is software. The operating system 500 allows the application 510 to access the processor 410, the memory 420, and the communications module 430 of the example computer device 400 (FIG. 4). The operating system 500 may be, for example, Google™ Android™, Apple™ iOS™, UNIX™, Linux™, Microsoft™ Windows™, Apple OSX™ or the like.

The application 510 adapts the example computer device 400, in combination with the operating system 500, to operate as a device performing a particular function. For example, the application 510 may cooperate with the operating system 500 to adapt a suitable embodiment of the example computer device 400 to operate as the computer device 340 (FIG. 2), the first server computer system 130 and/or the second server computer system 140.

While a single application 510 is illustrated in FIG. 5, in operation the memory 420 may include more than one application 510 and different applications 510 may perform different operations. For example, in at least some embodiments in which the computer device 400 is functioning as the second device 120, the applications 510 may include a banking application. The banking application may be configured for secure communications with the second server computer system 140 and may provide various banking functions such as, for example, the ability to display a quantum of value in one or more data records (e.g. display balances), configure or request that operations such as transfers of value (e.g. bill payments, email money transfers and other transfers) be performed, and other account management functions.

By way of further example, in at least some embodiments in which the computer device 400 functions as the second device 120, the applications 510 may include a web browser, which may also be referred to as an Internet browser. In at least some such embodiments, the second server computer system 140 may be a web server. The web server may cooperate with the web browser and may serve as an interface when the interface is requested through the web browser. For example, the web browser may serve as a mobile banking interface. The mobile banking interface may provide various banking functions such as, for example, the ability to display a quantum of value in one or more data records (e.g. display balances), configure or request that operations such as transfers of value (e.g. bill payments and other transfers) be performed, and other account management functions.

By way of further example, in at least some embodiments in which the computer device 400 functions as the second device 120, the applications 510 may include an electronic messaging application. The electronic messaging application may be configured to display a received electronic message such as an email message, short messaging service (SMS) message, or a message of another type. In at least some embodiments, the second server computer system 140 may be configured, through computer-executable instructions, to send an electronic message to the second device 120. For example, the second server computer system 140 may be configured to send a SMS message to a phone number associated with a user and an electronic messaging application on the second device 120 may be configured to retrieve the message and display the message to the user. As another example, the second server computer system 140 may be configured to send an email message to an email address associated with a user and an email application on the second device 120 may be configured to retrieve the message and display the message to the user.

As mentioned, the first server computer system 130 may include a plug-in module configured to enable one or more plug-ins capable of processing various tasks and/or operations responsive to input received from the first device 110. The plug-in module may correspond to first party applications and/or third-party applications operable to perform different tasks or actions. The plug-in modules may include, for example, Alexa Skills and/or Google Assistant Actions. Based on the context of audio received from the first device 110, the first server computer system 130 may use a certain plug-in module to retrieve or generate a response, which in turn may be communicated back to the first device 110.

In one or more embodiments, the plug-in module may allow the first server computer system 130 to communicate with the second server computer system 140. For example, the plug-in module may correspond to a third-party application such as for example a banking application. The banking application corresponding to the plug-in module may be similar to the banking application resident on the second device 120.

To enable a plug-in module on the first device 110, a user may be in the environment 160 and may submit voice input in the form of a voice utterance requesting that the plug-in be enabled. For example, where the first device 110 is an Amazon Echo, the user may say “Hey Alexa, enable The Banking Application.” The first device 110 may communicate the voice utterance as voice data to the first server computer system 130. The first server computer system 130 may analyze the voice data and convert the voice data to text using, for example, natural language processing. The text is then parsed and processed to determine an intent or command matching the voice utterance contained in the voice data and one or more parameters for the intent or command. Based on the intent or command and one or more parameters for the intent or command, the first server computer system 130 may identify the requested plug-in module and may accordingly enable the plug-in module. The user may alternatively enable the banking application by logging into their account associated with the first device 110 and this may be done using, for example, the second device 120.

As mentioned, in embodiments where the second server computer system 140 is associated with a financial institution, each account maintained by the second server computer system 140 may be associated with authentication information. The authentication information may be or may include any one or more of a token, a username, a password, a personal identification number (PIN), biometric data, etc. Responsive to the user enabling the plug-in module on the first device 110, the user may be prompted to enter authentication information to link the first device 110 to their account. For example, the second server computer system 140 may send a signal to the first server computer system 130 requesting authentication information. The first server computer system 130 may send a signal to the first device 110 causing the first device 110 to output a command requesting that the user authenticate the first device 110. The first device 110 may receive voice data that includes the authentication information. The second server computer system 140 may receive, from the first device 110 via the first server computer system 130, a signal that includes the authentication information and may identify, based on the authentication information, one or more accounts.

It will be appreciated that in one or more embodiments, the user may additionally or alternatively use the banking application or web browser executing on the second device 120 to enter authentication information to link the first device 110 to their account. The user may also select one or more permissions to be granted to the first device 110. For example, the user may provide read-only access to the first device 110. As another example, the user may permit the first device 110 to accept a transfer of funds into the account but may not permit the first device 110 to transfer funds out of the account. The user may also be prompted to (optionally) create a password such as a four-digit PIN that may be used by the first device 110 to authenticate the first device 110.

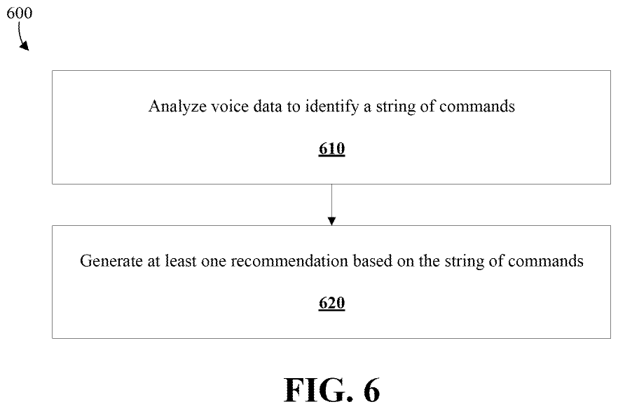

In one or more embodiments, the second server computer system 140 may include an artificial intelligence (AI) engine. The AI engine may utilize one or more machine learning techniques to analyze data to generate recommendations. The AI engine may be configured to analyze voice data received at the first device 110 to generate at least one AI-based recommendation. FIG. 6 is a flowchart showing operations performed by the AI engine of the second server computer system 140 in generating at least one recommendation. The operations may be included in a method 600 which may be performed by the AI engine of the second server computer system 140. For example, computer-executable instructions stored in memory of the second server computer system 140 may, when executed by one or more processors, configure the AI engine of the second server computer system 140 to perform the method 600.

The method 600 includes analyzing voice data to identify a string of commands (step 610).

In one or more embodiments, the voice data may include historical voice data based on one or more completed sessions with the first device 110. For example, the second server computer system 140 may store historical voice data based on one or more completed sessions with the first device 110 in a database. The one or more completed sessions may include sessions completed by an authenticated user communicating with the first device 110. The authenticated user may include a user that has an account maintained by the second server computer system 140 and as such the historical voice data may be stored in association with the account.

In one or more embodiments, the string of commands may include a sequence of two or more commands. The sequence of commands may include commands that are always received in a particular order. For example, the AI engine may analyze the historical voice data to determine that a first command is always received during an active voice session with the first device 110 and that a second command is always received after the first command during the active voice session. It will be appreciated that the sequence may include more than two commands.

In one or more embodiments, the string of commands may include a number of commands that are not necessarily always received in a particular order. For example, the AI engine may analyze the historical voice data to determine that a first command and a second command are always received during an active voice session but may not necessarily be received in a particular order.

In one or more embodiments, the AI engine may identify one or more commands that are more often than not received during an active voice session. For example, the AI engine may determine that a first command is received in more than half of the active voice sessions completed using the first device 110 and may determine that it is more likely than not that the first command may be received during the next active voice session with the first device 110.

The string of commands may include commands related to banking operations. For example, the string of commands may include commands related to paying bills. For example, the AI engine may identify that on the first of every month, an active voice session is completed that includes a first command to send money of a particular amount to a particular recipient and it may be determined that this is done to pay rent for a user. As another example, the AI engine may identify that a sequence of commands is received once per month during an active voice session that includes a command to pay a first type of bill, a command to pay a second type of bill, and a command to pay a third type of bill.

The AI engine may identify one or more commands that are always received during an active voice session. For example, the AI engine may identify that during every active voice session, the last command received is a command to check a balance of a particular bank account. As another example, the AI engine may identify that during every active voice session, a command to obtain a mortgage balance is always received.

The method 600 includes generating at least one recommendation based on the string of commands (step 620).

The at least one recommendation may be generated based on the historical voice data and may be used to reduce the amount of input and output required between the first device 110 and the second server computer system 140. As such, the overall communication between the first device 110 and the second server computer system 140 is reduced and as a result the amount of computing resources required to complete an active voice session is reduced.

As mentioned, the string of commands may include a sequence of two or more commands. In one or more embodiments, the recommendation may include causing the first device to automatically output data based on a second command of the sequence of two or more commands in response to causing the first device to output data based on a first command of the sequence of the two or more commands. In these embodiments, the first device automatically outputs data based on the second command of the sequence of two or more commands without actually receiving the second command as input. Put another way, in response to the first device receiving input that includes the first command, the first device may output data based on the first command and then may automatically output data based on the second command.

As an example, the AI engine may analyze the historical voice data to determine that a first command, such as transferring funds from a chequing account to a saving account, is always received during an active voice session with the first device 110 and that a second command, such as requesting an updated account balance of the savings account, is always received after the first command during the active voice session. As such, the recommendation may include outputting the account balance of the savings account automatically after transferring funds from a chequing account to the savings account. In this manner, data based on the second command may be output by the first device 110 without the first device 110 receiving the second command as input.

As another example, the at least one recommendation may include outputting data based on a particular command when it is determined that the active voice session is complete. For example, the AI engine may identify that during every active voice session, the last command received is a command to check a balance of a particular bank account. As such, when it is determined that an active voice session is complete, the at least one recommendation may include causing the first device 110 to automatically output the balance of the particular bank account without the first device 110 receiving the particular command as input.

As yet another example, the at least one recommendation may include activating a shortcut that may be used to cause the second server computer system 140 to perform one or more operations. For example, the AI engine may identify that a sequence of commands is received once per month during an active voice session that includes a command to pay a first type of bill, a command to pay a second type of bill, and a command to pay a third type of bill. As such, the at least one recommendation may include a recommendation to define a shortcut to pay the first type of bill, the second type of bill and the third type of bill based on a single command. The shortcut may be activated based on a particular intent or command that may be defined by the user as will be described in more detail below.

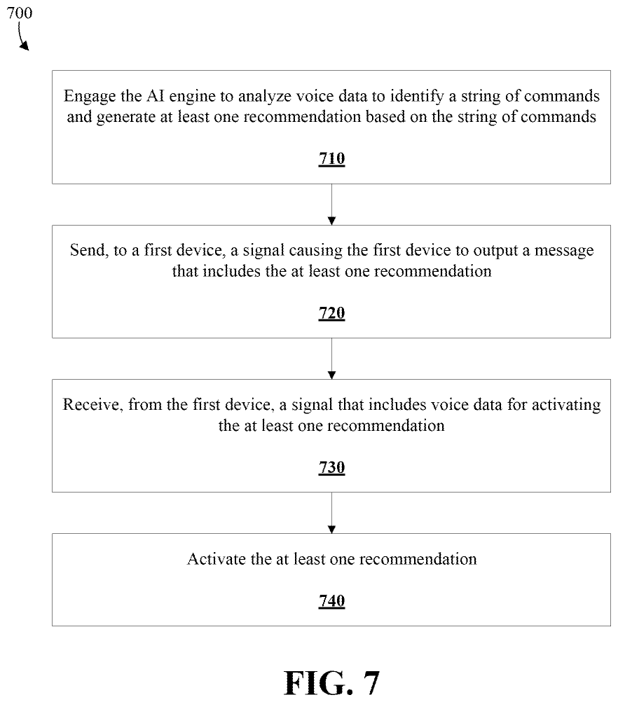

The second server computer system 140 may perform operations to activate the artificial intelligence-based recommendation generated by the AI engine. FIG. 7 is a flowchart showing operations performed by the second server computer system 140 in activating an artificial intelligence-based recommendation according to an embodiment. The operations may be included in a method 700 which may be performed by the second server computer system 140. For example, computer-executable instructions stored in memory of the second server computer system 140 may, when executed by one or more processors, configure the second server computer system 140 to perform the method 700 or a portion thereof. The second server computer system 140 may offload some of the operations to the first server computer system 130, the first device 110 and/or the second device 120.

The method 700 includes engaging the artificial intelligence (AI) engine to analyze voice data to identify a string of commands and generate at least one recommendation based on the string of commands (step 710).

The AI engine may be engaged by the second server computer system 140. As mentioned, in one or more embodiments the voice data may include historical voice data. During authentication of the first device 110, the second server computer system 140 may identify one or more accounts and may obtain, from a database, the historical voice data for the one or more accounts. The historical voice data may be sent to the AI engine for analysis to generate the at least one recommendation and this may be done in manners similar to that described herein with reference to the method 600.

In one or more embodiments, the second server computer system 140 may engage the AI engine in response to a determination that an active voice session has been initiated with the first device 110.

In one or more embodiments, the second server computer system 140 may engage the AI engine in response to a determination that sufficient voice data has been obtained from the first device 110. For example, a threshold may be defined for a minimum amount of complete voice sessions. The second server computer system 140 may engage the AI engine when it is determined that the first device 110 has completed the threshold amount of voice sessions. In this manner, the recommendations may be generated only when the threshold amount of voice sessions have been completed and this may be done to ensure the at least one recommendations are more accurately generated based on a large amount of voice data as compared to recommendations generated based on a single completed active voice session.

The method 700 includes sending, to a first device, a signal causing the first device to output a message that includes the at least one recommendation (step 720).

The second server computer system 140 may obtain the at least one recommendation from the AI engine and may generate a signal that may cause the first device 110 to output a message that includes the at least one recommendation.

In one or more embodiments, the second server computer system 140 may send the signal causing the first device 110 to output the message during an active voice session. For example, the at least one recommendation may be stored in a queue in association with the one or more accounts that have been identified during authentication of the first device 110. When it is determined that an active voice session has been initiated with the first device 110, the second server computer system 140 may send a signal causing the first device 110 to output a message such as “We have generated some recommendations to enhance your experience. Would you like to hear the recommendations?” The first device 110 may receive a command such as an indication that the user would like to hear the recommendations and may communicate the command to the second server computer system 140. In response, the second server computer system 140 may obtain the at least one recommendation from the queue and may send the signal causing the first device 110 to output the message that includes the at least one recommendation.

The message that includes the at least one recommendation may include a request for an indication that the user would like to activate the at least one recommendation. For example, the second server computer system 140 may concatenate a string of outputs together that includes the at least one recommendation and the request for the indication that the user would like to activate the at least one recommendation. As one example, the second server computer system 140 may concatenate at least one recommendation such as “We have noticed that you often pay three bills in succession on a particular date. We can set up a shortcut for you to pay all of these bills at once and this shortcut may be performed in response to you saying a particular command” with a default request for indication such as for example “Would you like us to activate this recommendation?” As such, the signal may cause the first device 110 to output a message “We have noticed that you often pay three bills in succession on a particular date. We can set up a shortcut for you to pay all of these bills at once and this shortcut may be performed in response to you saying a particular command. Would you like us to activate this recommendation?”

The method 700 includes receiving, from the first device, a signal that includes voice data for activating the at least one recommendation (step 730).

In one or more embodiments, a user may be in the environment 160 and may submit input in the form of a voice utterance that may be processed to determine that the at least one recommendation is to be activated. For example, the user may respond to the message that includes the at least one recommendation with “Yes, please activate.”

The voice data may include voice data received immediately after the at least one recommendation is output by the first device 110. For example, the first input received after the message that includes the at least one recommendation may be assumed to be a response as to whether or not the at least one recommendation is to be activated.

The method 700 includes activating the at least one recommendation (step 740).

Responsive to receiving the signal that includes voice data for activating the at least one recommendation, the second server computer system 140 activates the at least one recommendation. In one or more embodiments, activating the at least one recommendation may include updating or creating a data record that includes the recommendation and storing the updated or created data record in a database in association with the one or more account identified during authentication. Each time a voice session is initiated at the first device 110, the second server computer system 140 may consult the database to identify the recommendations activated for the account.

In one or more embodiments, a trigger may be defined for the at least one recommendation. The trigger may be, for example, an operation that is performed by the second server computer system 140 that causes or triggers the at least one recommendation to be performed and/or may be a particular command that is received by the first device 110 that, once completed, causes or triggers the at least one recommendation to be performed. For example, the at least one recommendation may include outputting the account balance of the savings account automatically after transferring funds from a chequing account to the savings account. As such, the trigger for the at least one recommendation may be defined as transferring funds from the chequing account to the savings account.

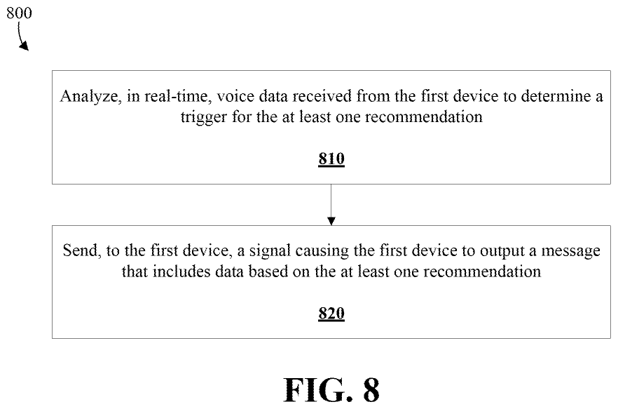

Once the at least one recommendation has been identified, the second server computer system 140 may perform operations to cause the first device to output a message that includes data based on the at least one recommendation. FIG. 8 is a flowchart showing operations performed by the second server computer system 140 in causing the first device to output a message that includes data based on the at least one recommendation according to an embodiment. The operations may be included in a method 800 which may be performed by the second server computer system 140. For example, computer-executable instructions stored in memory of the second server computer system 140 may, when executed by one or more processors, configure the second server computer system 140 to perform the method 800 or a portion thereof. The second server computer system 140 may offload some of the operations to the first server computer system 130, the first device 110 and/or the second device 120.

The method 800 includes analyzing, in real-time, voice data received from the first device to determine a trigger for the at least one recommendation (step 810).

As mentioned, a trigger may be defined for the at least one recommendation. As such, during an active voice session, the second server computer system 140 may analyze, in real-time, voice data received from the first device 110 to determine the trigger for the at least one recommendation.

As one example, the trigger for the at least one recommendation may be defined as transferring funds from the chequing account to the savings account. As such, the second server computer system 140 may analyze, in real-time, voice data received from the first device and may determine that a command has been received to transfer funds from the chequing account to the savings account and may determine the trigger.

The method 800 includes sending, to the first device, a signal causing the first device to output a message that includes data based on the at least one recommendation (step 820).

Responsive to determining the trigger for the at least one recommendation, the second server computer system 140 may send a signal causing the first device to output a message that includes data based on the at least one recommendation.

In one or more embodiments, the second server computer system 140 may obtain the data based on the at least one recommendation from at least one data record. For example, the trigger for the at least one recommendation may be defined as transferring funds from the chequing account to the savings account and the at least one recommendation may include outputting the account balance of the savings account. As such, the second server computer system 140 may obtain the account balance of the savings account from a data record associated with the savings account and may send, to the first device 110, a signal causing the first device to output a message that includes the balance of the savings account in accordance with the at least one recommendation.

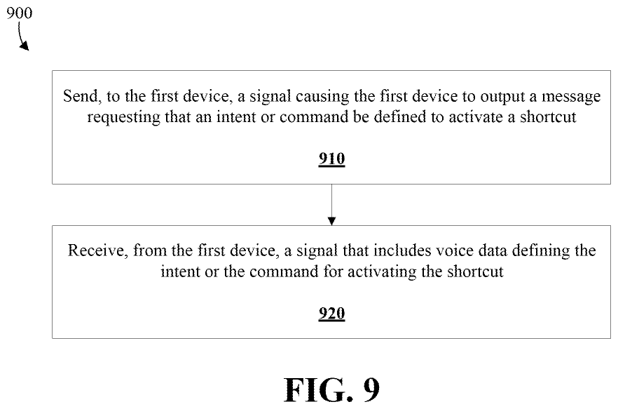

As mentioned, in one or more embodiments, the at least one recommendation may include a recommendation to activate a shortcut for causing the second server computer system to perform one or more operations. For example, the at least one recommendation may include a recommendation to pay a first type of bill, a second type of bill and a third type of bill based on a single command. The shortcut may be activated based on a particular intent or command that may be defined by the user. FIG. 9 is a flowchart showing operations performed by the second server computer system 140 in defining an intent or command for activating a shortcut according to an embodiment. The operations may be included in a method 900 which may be performed by the second server computer system 140. For example, computer-executable instructions stored in memory of the second server computer system 140 may, when executed by one or more processors, configure the second server computer system 140 to perform the method 900 or a portion thereof. The second server computer system 140 may offload some of the operations to the first server computer system 130, the first device 110 and/or the second device 120.

The method 900 includes sending, to the first device, a signal causing the first device to output a message requesting that an intent or command be defined to activate the shortcut (step 910).

In one or more embodiments, the message requesting that the intent or command be defined to activate the shortcut may be output after receiving the signal that includes voice data for activating the at least one recommendation. As one example, the signal may cause the first device to output a message such as “Please define a word or phrase you would like to use to activate this shortcut.”

In one or more embodiments, the message may include a recommended word or phrase. For example, the at least one recommendation may include a recommendation to pay a first type of bill, a second type of bill and a third type of bill based on a single command. In this example, the signal may cause the first device to output a message such as “Please define a word or phrase you would like to use to activate this shortcut. For this shortcut, we recommend using “Pay my bills. Is this phrase okay?”

The method 900 includes receiving, from the first device, a signal that includes voice data defining the intent or the command for activating the shortcut (step 920).

The second server computer system 140 may receive the signal that includes voice data defining the intent or the command for activating the shortcut. As one example, the signal may include a word or a phrase to be used for the shortcut. As another example, the signal may indicate that the recommended word or phrase has been accepted and is to be used.

In response, the second server computer system 140 may update the at least one recommendation to include the intent or command for activating the shortcut and this may be stored in the database in manners similar to that described herein.

It will be appreciated that in one or more embodiments, multiple words or phrases may be used to activate the shortcut and may be stored in the database for the at least one recommendation. The multiple words or phrases may be a string of words or phrases or may be alternative words of phrases such that any one of the words or phrases may be used to activate the shortcut.

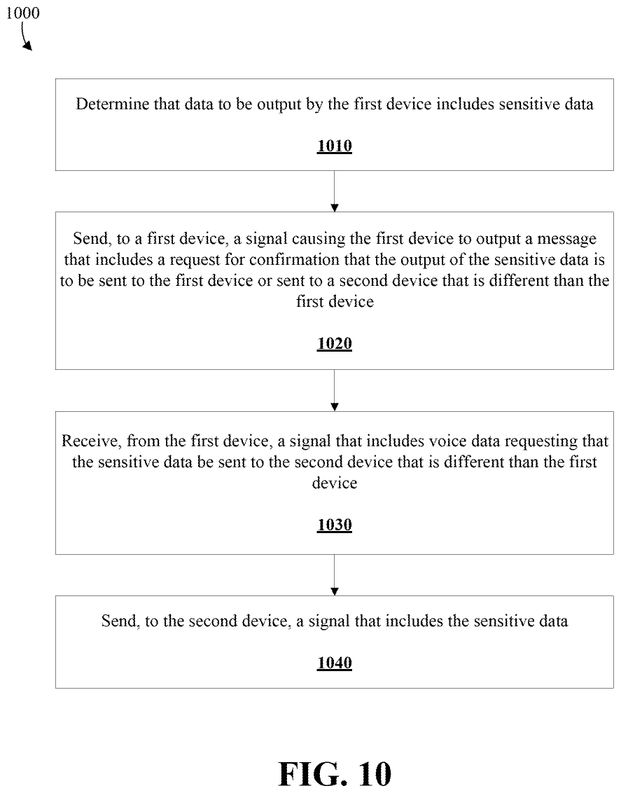

In one or more embodiments, data to be output by the first device 110 may include sensitive data and as such the second server computer system 140 may pass the data through a filter to determine whether or not the data includes sensitive data. When it is determined that the data includes sensitive data, the second server computer system 140 may perform operations to send the sensitive data to an alternative device such as for example the second device 120. FIG. 10 is a flowchart showing operations performed by the second server computer system 140 in sending, to a second device, a signal that includes sensitive data according to an embodiment. The operations may be included in a method 1000 which may be performed by the second server computer system 140. For example, computer-executable instructions stored in memory of the second server computer system 140 may, when executed by one or more processors, configure the second server computer system 140 to perform the method 1000 or a portion thereof. The second server computer system 140 may offload some of the operations to the first server computer system 130, the first device 110 and/or the second device 120.

The method 1000 includes determining that data to be output by the first device includes sensitive data (step 1010).

In one or more embodiments, prior to sending the data to be output by the first device, the data may be put through a filter to determine whether or not the data includes sensitive data. Sensitive data may include data that a user is unlikely to want to share with others such as for example an account balance, a mortgage balance, personal information such as a social insurance number, etc.

In one or more embodiments, determining that data to be output by the first device includes sensitive data may be performed based on a command received by the first device. For example, the first device may receive a command to retrieve an account balance and it may be determined, based on the command, that the data to be output by the first device includes sensitive data.

The method 1000 includes sending, to the first device, a signal causing the first device to output a message that includes a request for confirmation that the output of the sensitive data is to be sent to the first device or to a second device that is different than the first device (step 1020).

Responsive to determining that the data to be output by the first device includes sensitive data, the second server computer system 140 may send a signal causing the first device to output a message that includes a request for confirmation that the output of the sensitive data is to be sent to the first device or to a second device that is different than the first device.

In one or more embodiments, the second device may include the second device 120 described herein and may be identified automatically by the second server computer system 140 based on the account identified during authentication of the first device 110. The second device 120 may be, for example, identified by determining a mobile phone number or an email address of the user which may be stored in a database in association with the account.

The method 1000 includes receiving, from the first device, a signal that includes voice data requesting that the sensitive data be sent to the second device that is different than the first device (step 1030).

The voice data may be obtained by the first device 110. The voice data may request that the sensitive data be sent to the second device that is different than the first device.

The method 1000 includes sending, to the second device, a signal that includes the sensitive data (step 1040).

The second server computer system 140 may send a signal that includes the sensitive data to the second device 120. In one or more embodiments, the sensitive data may be sent to the second device via text message and this may be done using the mobile phone number of the user.

Of course, the voice data may request that the sensitive data be sent to the first device 110 and in response the second server computer system 140 may send a signal to the first device 110 that causes the first device 110 to output a message that includes the sensitive data.

In one or more embodiments, the second device may be unknown to the second server computer system 140 and as such the second server computer system 140 may send a signal to the first device 110 that causes the first device 110 to output a message that includes a request for a mobile phone number or email address that is to be used to receive the sensitive data.

In one or more embodiments described herein, the voice data may be processed by the first device 110 and/or the first server computer system 130 prior to being communicated to the second server computer system 140. For example, the first device 110 may communicate a voice utterance as voice data to the first server computer system 130. The first server computer system 130 may analyze the voice data and convert the voice data to text using, for example, natural language processing. The text may then be parsed and processed to determine an intent or command matching the voice utterance contained in the voice data and one or more parameters for the intent or command. The intent or command and the one or more parameters may be communicated to the second server computer system 140 for processing and this may be done according to manners described herein.

Of course, the voice data may be processed by the second server computer system 140. For example, the first device 110 may communicate a voice utterance as voice data to the second server computer system 140 and this may be done directly or by way of the first server computer system 130. The second server computer system 140 may analyze the voice data and convert the voice data to text using, for example, natural language processing. The text may then be parsed and processed to determine an intent or command matching the voice utterance contained in the voice data and one or more parameters for the intent or command.

In embodiments described herein, examples are provided where the second server computer system 140 may be used to pay one or more bills for a user. In one or more embodiments, the second server computer system 140 may communicate with one or more application programming interfaces (APIs) to obtain billing information from one or more third parties and as such may automatically determine an amount to pay the biller. For example, within a mobile banking application, the user may provide account information for their cable television account. The second server computer system 140 may use this account information to communicate with a server associated with the cable television provider to obtain billing information such as a total amount of the bill and may pay the bill on the user's behalf in response to a command received via the first device 110.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

What is claimed is:

1. A server computer system comprising:
a communications module;
a processor coupled with the communications module; and
a memory coupled to the processor and storing processor-executable instructions which, when executed by the processor, configure the processor to:
engage an artificial intelligence (AI) engine to:
analyze voice data to identify a string of commands; and
generate at least one recommendation based on the string of commands;
send, via the communications module to a first device, a signal causing the first device to output a message that includes the at least one recommendation;
receive, via the communications module and from the first device, a signal that includes voice data for activating the at least one recommendation; and
activate the at least one recommendation.

2. The server computer system of claim 1, wherein the processor-executable instructions, when executed by the processor, further configure the processor to:
analyze, in real-time, voice data received from the first device to determine a trigger for the at least one recommendation; and
send, via the communications module and to the first device, a signal causing the first device to output a message that includes data based on the at least one recommendation.

3. The server computer system of claim 2, wherein the processor-executable instructions, when executed by the processor, further configure the processor to:
obtain the data based on the at least one recommendation from at least one data record.

4. The server computer system of claim 1, wherein the voice data includes historical voice data based on one or more completed sessions with the first device.

5. The server computer system of claim 1, wherein the string of commands includes a sequence of two or more commands and the recommendation includes automatically causing the first device to output data based on a second command of the sequence of the two or more commands in response to causing the first device to output data based on a first command of the sequence of the two or more commands.

6. The server computer system of claim 1, wherein the recommendation includes activating a shortcut for causing the server computer system to perform one or more operations.

7. The server computer system of claim 6, wherein the processor-executable instructions, when executed by the processor, further configure the processor to:
send, via the communications module and to the first device, a signal causing the first device to output a message requesting that an intent or command be defined to activate the shortcut; and
receive, via the communications module and from the first device, a signal that includes voice data defining the intent or the command for activating the shortcut.

8. The server computer system of claim 1, wherein the processor-executable instructions, when executed by the processor, further configure the processor to:
determine that data to be output by the first device includes sensitive data;
send, to the first device, a signal causing the first device to output a message that includes a request for confirmation that the output of the sensitive data is to be sent to the first device or sent to a second device that is different than the first device;
receive, via the communications module and from the first device, a signal that includes voice data requesting that the sensitive data be sent to the second device that is different than the first device; and
send, via the communications module and to the second device, a signal that includes the sensitive data.

9. The server computer system of claim 8, wherein the sensitive data is sent to the second device via text message.

10. The server computer system of claim 1, wherein the processor-executable instructions, when executed by the processor, further configure the processor to:
receive, via the communications module and from the first device, a signal that includes authentication information;
identify, based on the authentication information, one or more accounts; and
obtain, from a database, the voice data based on the one or more accounts.

11. A computer-implemented method performed by a processor of a computer server system, the method comprising:
engage an artificial intelligence (AI) engine to:
analyze voice data to identify a string of commands; and
generate at least one recommendation based on the string of commands;
send, via a communications module to a first device, a signal causing the first device to output a message that includes the at least one recommendation;
receive, via the communications module and from the first device, a signal that includes voice data for activating the at least one recommendation; and
activate the at least one recommendation.

12. The computer-implemented method of claim 11, further comprising:
analyzing, in real-time, voice data received from the first device to determine a trigger for the at least one recommendation; and
sending, via the communications module and to the first device, a signal causing the first device to output a message that includes data based on the at least one recommendation.

13. The computer-implemented method of claim 12, further comprising:
obtaining the data based on the at least one recommendation from at least one data record.

14. The computer-implemented method of claim 11, wherein the voice data includes historical voice data based on one or more completed sessions with the first device.

15. The computer-implemented method of claim 11, wherein the string of commands includes a sequence of two or more commands and the recommendation includes automatically causing the first device to output data based on a second command of the sequence of the two or more commands in response to causing the first device to output data based on a first command of the sequence of the two or more commands.

16. The computer-implemented method of claim 11, wherein the recommendation includes activating a shortcut for causing the server computer system to perform one or more operations.

17. The computer-implemented method of claim 16, further comprising:
sending, via the communications module and to the first device, a signal causing the first device to output a message requesting that an intent or command be defined to activate the shortcut; and
receiving, via the communications module and from the first device, a signal that includes voice data defining the intent or the command for activating the shortcut.

18. The computer-implemented method of claim 11, further comprising:
determining that data to be output by the first device includes sensitive data;
sending, to the first device, a signal causing the first device to output a message that includes a request for confirmation that the output of the sensitive data is to be sent to the first device or sent to a second device that is different than the first device;
receiving, via the communications module and from the first device, a signal that includes voice data requesting that the sensitive data be sent to the second device that is different than the first device; and
sending, via the communications module and to the second device, a signal that includes the sensitive data.

19. The computer-implemented method of claim 18, wherein the sensitive data is sent to the second device via text message.

20. A non-transitory computer readable storage medium comprising computer-executable instructions which, when executed, configure a processor of a computer server system to:
engage an artificial intelligence (AI) engine to:
analyze voice data to identify a string of commands; and
generate at least one recommendation based on the string of commands;
send, via a communications module to a first device, a signal causing the first device to output a message that includes the at least one recommendation;
receive, via the communications module and from the first device, a signal that includes voice data for activating the at least one recommendation; and
activate the at least one recommendation.
